(19) United States
(12) Patent Application Publication
(10) Pub. No.: US 2025/0046156 A1
(43) Pub. Date: Feb. 6, 2025

(54) SYSTEM AND METHOD FOR PEER-TO-PEER AND NON-CUSTODIAL WAGERING

(71) Applicant: THNDR LTD, LONDON (GB)

(72) Inventors: Jack EVERITT, Chelmsford (GB); Grzegorz FLOR, Krakow (PL); Rafal GAWEL, Wieliczka (PL); Desiree DICKERSON, Washington, DC, DC (US)

(21) Appl. No.: 18/778,399

(22) Filed: Jul. 19, 2024

Related U.S. Application Data
(60) Provisional application No. 63/527,644, filed on Jul. 19, 2023.

(51) Int. Cl. G07F 17/32; G06Q 30/0241; H04L 67/104

(52) U.S. Cl. CPC G07F 17/3288; G06Q 30/0241; H04L 67/104

(57) ABSTRACT

A system and method for facilitating a non-custodial, peer-to-peer wagered event for users. The system has an arbiter module configured to facilitate a selection of wagering terms. The system also provides a smart wager module configured to create and manage smart contracts that has the wagering terms. A lightning service provider manager module also disclosed to ensure a payment capacity and a liquidity, thereby allowing a settlement of the smart contracts. Finally, the system has an oracle module to verify and confirm a validity of the wagered event.

### BACKGROUND

The present invention generally relates to a peer-to-peer wagering and gaming software platforms. More specifically, the present invention relates to a system and method for facilitating a non-custodial, peer-to-peer wagered event for users. The system enables users to use cryptocurrency networks, such as Bitcoin, as well as second layer payment protocols, such as the Lightning Network, to create a non-custodial, peer-to-peer wagers with cryptocurrency assets (e.g. bitcoin, stablecoins, fungible tokens, non-fungible tokens (NFTs), and other digital assets like BRC-20).

Generally, all aspects of a wager in an online setting require a centralized intermediary to not only host and act as an arbiter, but also collect, hold, and transfer user's funds. The arbiter can be an automated system module responsible for managing wager-based matchmaking. Existing peer-to-peer wagering platforms are only function in peer-to-peer setting as matchmaking. The settlement of stakes in a wager is not performed as peer-to-peer but rather occurs in a custodial manner. In other words, such platforms perform a similar function to a bank by controlling a ledger, updating balances for the users of the system, and distributing funds.

These and similar systems that run a custodial ledger to settle wagers require significant cost for the arbiter. Regulation, compliance, trust, and security requirements introduce significant financial and legal barriers to set up, execute, and maintain a wager platform. Centralized ledgers make it nearly impossible to introduce micropayments and cross-border payments to online systems.

A solution therefore is needed to solve the need for a centralized ledger by utilizing cryptographic payment networks, such as the Lightning Network, reducing cost and regulatory burden on the arbiter. The low cost and ease of sending micropayments over blockchain-based payment networks, such as Bitcoin's Lightning Network can make wagering technology feasible for businesses and accessible to more audiences and demographics. Additionally, the present invention addresses configuration where users do not rely on the arbiter to secure their staked funds in the wager unlike systems that currently exist.

### SUMMARY

According to a non-limiting embodiment of the present invention, a system and method for facilitating a non-custodial, peer-to-peer wagered event for users. The system has an arbiter module configured to facilitate a selection of wagering terms. The system also provides a smart wager module configured to create and manage smart contracts that have the wagering terms. A lightning service provider manager module also disclosed to ensure a payment capacity and a liquidity, thereby allowing a settlement of the smart contracts. Finally, the system has an oracle module to verify and confirm a validity of the wagered event.

In another aspect of the invention, a method for a non-custodial, peer-to-peer wagered event for users. The method provides for publishing an online non-custodial, peer-to-peer wagered event using an arbiter module and matching the users with the wagered event, wherein the users opt-in to initiate a wager. The method further provides for creating a smart wager by a smart wager module, wherein the smart wager module comprises individual smart contracts for each user with associated the wagering terms, and optionally, hosting the wagered event in an online environment. Finally, the method provides for determining a validity of the wagered event in an online environment by comparing event actions to anticipated outcomes generated by the wagered event via oracle module, wherein the oracle module comprises an event verifier, and settling the smart wager through the arbiter module.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a diagram of an exemplary application development environment workflow in accordance with embodiments of this invention;

FIG. 2 depicts a diagram of an smart wager module in accordance with embodiments of this invention;

FIG. 3 depicts a diagram of a smart contract creator in accordance with embodiments of this invention;

FIG. 4 depicts a diagram of an embodiment of the system in accordance with embodiments of this invention;

FIG. 5 depicts a flow chart of creating a wager between two players using the system in accordance with embodiments of this invention;

FIG. 6 depicts a diagram of an settlement of a wager by the system in accordance with embodiments of this invention;

FIG. 7 depicts a diagram of a lightning service provider (LSP) manager module in accordance with embodiments of this invention;

FIG. 8 depicts a diagram of an event verifier in accordance with embodiments of this invention;

FIG. 9 depicts a diagram of an exemplary embodiment of a method in accordance with embodiments of this invention; and

FIG. 10 depicts a diagram illustrating a user interface flowchart of the system from the user's perspective according to embodiment of the present invention.

In the accompanying figures and following detailed description of the described embodiments, the various elements illustrated in the figures are provided with two, three or four digit reference numbers. With minor exceptions, the leftmost digit(s) of each reference number correspond to the figure in which its element is first illustrated.

### DETAILED DESCRIPTION

Reference to “a specific embodiment” or a similar expression in the specification means that specific features, structures, or characteristics described in the specific embodiments are included in at least one specific embodiment of the present invention. Hence, the wording “in a specific embodiment” or a similar expression in this specification does not necessarily refer to the same specific embodiment.

Hereinafter, various embodiments of the present invention will be described in more detail with reference to the accompanying drawings. Nevertheless, it should be understood that the present invention could be modified by those skilled in the art in accordance with the following description to achieve the excellent results of the present invention. Therefore, the following description shall be considered as a pervasive and explanatory description related to the present invention for those skilled in the art, not intended to limit the claims of the present invention.

Reference to “an embodiment,” “a certain embodiment” or a similar expression in the specification means that related features, structures, or characteristics described in the embodiment are included in at least one embodiment of the present invention. Hence, the wording “in an embodiment,” “in a certain embodiment” or a similar expression in this specification does not necessarily refer to the same specific embodiment.

For illustrative purposes only and not to limit the present disclosure, the following terms are used to describe the present invention.

### General Definitions

Wager: A contractual agreement entered into by two or more users. The agreement generally entails the commitment of assets possessing value, which are staked on the outcome of a future Event (as this term defined in this disclosure).

Blind Wager: In this wager, the users remain unaware of their opponent's identity until the Wager commences and is revealed by the Arbiter System (as this term is defined in this disclosure). This method is typically employed in scenarios involving ‘games of skill’, where the Arbiter matchmaking process considers users' skill levels to assure fair and balanced competition. In this case, the Arbiter establishes an environment for users to join a Wager, and subsequently matches the users based on their skill levels into the environment. A user selects a Wager based on the Wager Terms (as this term is defined in this disclosure), unaware of the identity of their competitor, which is only revealed once the skill-based event starts or after a user completes their part in the event, with a competitor matched later by the Arbiter.

Transparent Wager: Users are provided with additional information about their opponent before entering the Wager. Commonly used in ‘games of skill’, it allows a user to assess their competitor's attributes before committing to the wager. These Wagers can either be publicly listed for global access or specifically advertised among acquaintances. In another instance, a Wager could be based on the outcome of an observed Event that the users do not directly participate in, thereby not having influence over the outcome of the Event. Another example is in a peer-to-peer sportsbook, where users of the sportsbook website can list their bets on a public forum for other users to match with.

House Wager: A House Wager is utilized when there is no opposing user available to complete the other side of the wager. In such cases, the ‘house’ or the Arbiter presents Wagers for users to compete against the house. This type of Wager is commonly found in scenarios like sports betting, where a bookmaker provides odds to users for wagers based on an “Observed Event” (as this term is defined in this disclosure), in which the User does not participate,

Event: A future occurrence with multiple potential outcomes, upon which two or more parties can place a wager. An Event may occur virtually, such as within an online environment, or transpire in the physical world. Examples are online video games, sporting competitions, and elections. Events can be defined as, but not limited to, Direct Participation Event, Observed Event, or Oracle-reliant Event (as these terms are defined in this disclosure).

Direct Participation Event: Users wager on Events that they are actively participate in, for example placing a bet on their performance in an online video game.

Observed Event: Users place wagers on Events they observe but do not participate in, for example betting on the outcome of a football match, pageant, or video game tournament they are watching.

Oracle-reliant Event: Users place wagers on Events where they neither observe nor participate, instead users rely on an Oracle to determine the outcome. For example, wagering on the outcome of a political election, where the user cannot verify the accuracy of the results themself.

Action: Any verifiable act or deed executed within the context of an Event. An example of an Action can be a specific move made in a game or playing a hand of cards in a round of Poker, or any other measurable activity related to the Event. These Actions are recordable and can serve as empirical evidence or data points that an Oracle can utilize to confirm, validate, or verify the outcomes of the Event.

Round: A distinct segment or subdivision within an Event. Each Round may comprise one or more Actions that collectively lead to an intermediate outcome or result within the overarching Event. For example, a Round could represent a hand of cards in a Poker game, with each hand involving multiple Actions. Multiple Rounds, in turn, would constitute a complete Poker Tournament, which represents the broader Event.

user: User refers to any individual, group, or entity interacting with the wagering system. A user's primary role involves acting as a party that places a wager, which is based on the outcome of an Event. This role may encompass selecting Wager Terms (as such term defined in this disclosure), performing Actions in the context of a Direct Participation Event, and participating in the distribution of staked assets based on the Event's outcome.

Arbiter: An automated system module responsible for managing wager-based matchmaking. This includes enforcing Wager Terms and refining matches based on participant attributes. In certain embodiments, an Arbiter can also function as a user, placing wagers, and an Oracle (as such term defined in this disclosure), determining event outcomes, akin to the role of a bookie in traditional settings.

Oracle: A component within the system, which could be an individual, group, or automated module, entrusted with determining and declaring the outcome of a specific event relevant to a wager. The Oracle, being integral to the system's function, is assumed to be reliable and impartial. It delivers factual information about event outcomes, which is vital for establishing the results of the wager. The Oracle may use the Event Verifier system to attest the results. The range of events which the Oracle verifies can span across various domains, e.g., from online games and sports matches to any other scenarios pertinent for wagering.

Wager Terms: The specific conditions and parameters that govern a wager. These may include, but are not limited to, the type and amount of the stake (e.g., Bitcoin, Fiat current, NFTs etc.), the identity and characteristics of the Event, length of the wager, the criteria for determining the outcome, and the methods for distribution of the staked assets upon the Event's conclusion via a Smart Contract. Wager Terms are agreed upon by the participating Users and enforced by the Arbiter.

Event Verifier: A system or mechanism designed to validate and authenticate a participant's Actions during an online Event. Event Verifier's primary function is to ensure the legitimacy of the Actions, for example by confirming that no fraudulent or dishonest behaviors, such as cheating, occurred during the course of the Event. It achieves this by scrutinizing and analyzing the record of Actions performed by the participant during the Event.

Smart Contract: Any cryptographic payment contract between two or more parties that executes and settles once the conditions of the contract are satisfied. Smart Contracts include, but are not limited to, Discreet Log Contracts, Hash Time-Locked Contracts, Point Time-Locked Contracts and HODL Invoices.

Discreet Log Contract (DLC): A type of cryptographic Smart Contract that leverages cryptographic primitives to enable the creation of enforceable agreements without the need for trust in a centralized intermediary. The DLC Smart Contract may be deployed on the Bitcoin blockchain base layer or a second layer protocol such as the Lightning Network.

Hashed Time-Locked Contract (HTLC): A cryptographic Smart Contract that utilizes cryptographic hashes and time locks to enforce conditional requirements for the release of funds. HTLCs reduce counterparty risk and enable secure and conditional payments by creating a time-based escrow that requires a cryptographic passphrase for unlocking.

Point Time-Locked Contract (PTLC): A cryptographic Smart Contract that can replace the use of HTLCs in payment channels and other contract protocols. PTLCs use adaptor signatures and combined with key aggregation to create an alternate clause for redemption. They require that the receiver reveals a private key (the hidden value) to a specified public key in order to claim the funds.

HODL Invoice: A HODL invoice, short for “Hold On for Dear Life” invoice, is a specialized payment request that allows the recipient to hold a payment without settling the transaction immediately. This mechanism essentially “locks” the funds, ensuring they cannot be spent until the invoice is settled or the payment is released by the recipient.

Smart Wager: This is a set of Smart Contracts generated by the Arbiter for the wager between the users. The Smart Wager enables the Arbiter system to facilitate a non-custodial escrow. The Smart Wager contains individual contracts, with associated contract terms, for each potential outcome. The Arbiter retains exclusive authority to reveal the essential information to the Smart Wager, and chooses the Smart Contracts in the Smart Wager to be settled (by revealing the essential information) based on the Oracle's input. For demonstration purposes only, in a two-user wager using HTLCs, two Smart Contracts are established in the Smart Wager: One from User 1 to User 2—for if User 2 wins and One from User 2 to User 1—for if User 1 wins. The Arbiter informs the Smart Wager which user won to settle the Wager. In case of a draw, no contracts are settled; instead, they are either canceled or they expire after a specified period of time.

Secret: A private key or secret value that is used in HTLCs, PTLCs, DLCs and other similar Smart Contracts.

Stake: A stake is a value the user risks in order to enter into a Wager. Types of stakes include, but are not limited to, bitcoin (sats), stable coins, and NFTs.

Payee Method: Refers to the mechanism through which a user receives funds. This could encompass methods like a Bitcoin address, a Lightning invoice (including BOLT 11, 12, or future iterations), Lightning address, LNURL pay, among others.

In the ever-evolving sphere of online wagering, technological advancements have been instrumental in reshaping the landscape of online wagering industry and how users engage with online platforms and paces their Stakes. Peer-to-peer (P2P) wagering, is where users can wager their Stakes directly against each other. This decentralized approach allows users to create and accept wagers, negotiate terms, and set odds without a central bookmaker.

Traditional wagering platforms and services do not allow users to enter customized wagers and enabling users to customize wagers (e.g., physical goods, virtual goods), conditions, parameters associated with the wager, and/or selecting various means of validation, among other examples. For maintaining ledgers of transactional activity, such traditional platforms or services may also lead to less accurate transactional records that do not adequately reflect the nature of a specific wager.

These custodial ledgers used to settle wagers require significant cost for the arbiter. Regulation, compliance, trust, and security requirements that are necessary for P2P wagering introduce significant financial and legal barriers to set up, execute, and maintain a wager platform. Moreover, centralized ledgers make it nearly impossible to introduce micropayments and cross-border payments to online systems.

A solution therefore is needed to solve the need for a centralized ledger by utilizing cryptographic payment networks, such as the Lightning Network, reducing cost and regulatory burden on the arbiter. The low cost and ease of sending micropayments over blockchain-based payment networks, such as Bitcoin's Lightning Network can make wagering technology feasible for businesses and accessible to more audiences and demographics. Additionally, the present invention addresses configuration where users do not rely on the arbiter to secure their staked funds in the wager unlike systems that currently exist.

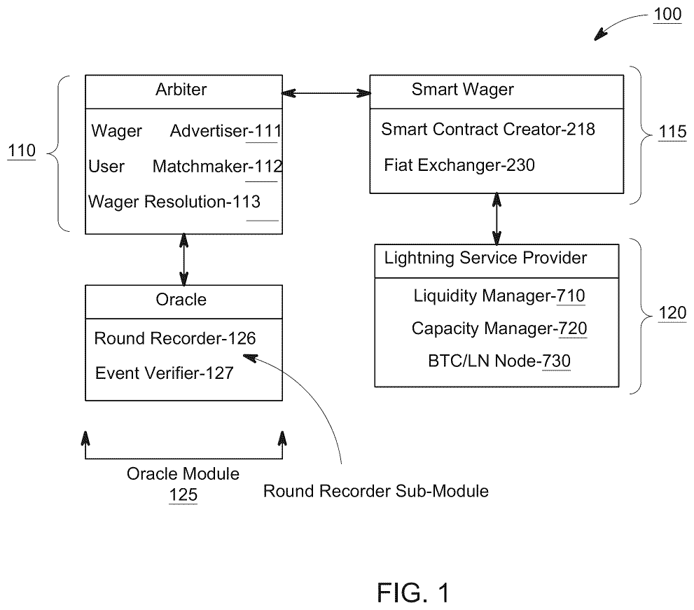

A system 100 according to embodiments of the present invention as described below and illustrated through FIGS. 1-10, enables a user to use cryptocurrency networks, such as Bitcoin, as well as second layer payment protocols, such as the Lightning Network, to create a non-custodial, peer-to-peer wagers with cryptocurrency assets (e.g. bitcoin, stablecoins, fungible tokens, non-fungible tokens (NFTs), and other digital assets like BRC-20).

In particular, as illustrated in FIG. 1, the system 100 according to embodiments of the present invention provides a solution for facilitating a non-custodial, peer-to-peer Wagered Event for a user. The system can have an arbiter module 110 configured to facilitate a selection of Wagering Terms, a smart wager module 115 configured to create and manage Smart Contracts that incorporate the Wagering Terms, a lightning service provider manager module 120 configured to ensure a payment capacity and a liquidity thereby allowing a settlement of the Smart Contracts, an oracle module 125 to verify and confirm a validity of the Wagered Event.

Each module shown in FIG. 1, i.e., the arbiter module 110, the smart wager module 115, the lightning service provider manager module 120, and the oracle module 125 can perform their respective functionalities independently and can be integrated with third party solutions, for example in the use case of prediction markets, the arbiter module 110 and smart wager module 115 could be combined with a third party oracle service to determine a result. In particular, a prediction wager can be “who will the next president be”, and the oracle in that case is the electoral authority. Alternatively, the modules form a comprehensive wagering system 100 suitable for various applications, including, but not limited to, wagering on online games of skill or sports wagering.

As shown in FIG. 1, the arbiter module 110 is configured to manage the matchmaking process for a wager-based engagements. The arbiter module 110 primary functionality is to facilitate the selection of Wager Terms, for example the type and amount of the stake (e.g., Bitcoin, Fiat current, NFTs etc), the identity and characteristics of the Event, length of the wager, the criteria for determining the outcome, and the methods for distribution of the staked assets upon the Event's conclusion via a Smart Contract.

In addition, the arbiter module 110 can refine the matchmaking process by utilizing additional participant attributes such as ELO scoring of users' ability. That is, the arbiter module 110 can also represent the facilitator role traditionally filled by entities like online gaming platform operators or sports bookies.

In some embodiments of the present invention, the arbiter module 110 can operate simultaneously as a user, who matches an Open Wager, and as an Oracle, which determines the outcomes of events. For instance, a bookie within the system might act as an all-encompassing entity-matching open wagers, managing arbitration, and determining outcomes.

The arbiter module 110 can be provided with sub-modules (as shown in FIG. 1), such as, a Wager Advertiser 111, a User Matchmaker 112, and a Wager Resolution 113.

The Wager Advertiser 111 is configured to publish all available wagers to users via an interface, application programming interface (API), or social media applications (e.g., Notes and Other Stuff Transmitted by Relays (NOSTR) ecosystem), thereby facilitating users' engagement in a wager under their preferred Wager Terms. Wagers are categorized into at least three main types: Blind Wager, Transparent Wager, and House Wager. The Wager Advertiser 111 can advertise one or more categories of Wager. For example, Wagers are optionally advertised on the NOSTR social network, and in particular, Wager Terms are published with Note over a relay and users on the NOSTR can reply to the Notes to accept or reject the Wager Terms.

The User Matchmaker 112 is configured to link users according to their selected Wager Terms, e.g., Preferred Smart Wager Type, Stake type, and Stake amount. The User Matchmaker 112 can offer preset Wager Terms for user selection to simplify matchmaking. Users who match based on Wager Terms will then be matched based on their prior skills or other attributes determined by the User Matchmaker 112. The User Matchmaker 112 can employ factors such as the user's wallet software and personal preferences to choose the types of Smart Contract for the Smart Wagers via the API (not shown).

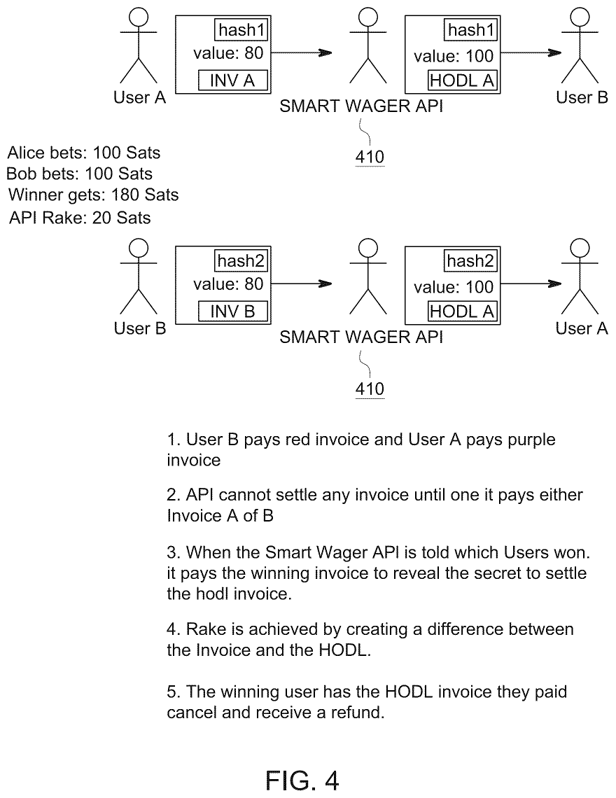

The Wager Resolution 113 can interact with the smart wager module 115 a Smart Wager API 410 (shown in FIG. 4) when determining the winner and how to settle the Smart Wager.

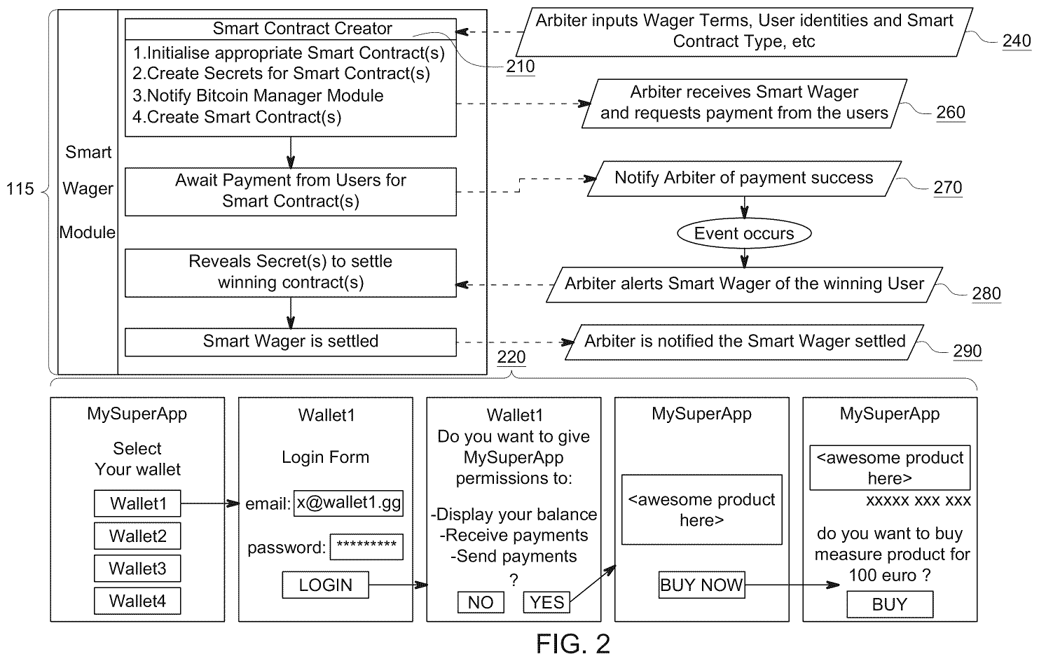

FIG. 2 illustrates the smart wager module 115 according to embodiments of the present invention. As shown in FIG. 2, when the user selects a wager in which he or she chooses to participate and as advertised by the Arbiter of the arbiter module 110, the user can deposit his or her funds with the smart wager module 115. The smart wager module 115 can have a smart contract creator 210 that is configured to create and manage Smart Contract(s) for the Arbiter (as shown in FIG. 2).

More specifically, according to embodiment of the present invention, the Arbiter inputs Wager Terms, User Identification, Smart Contract Type and other information necessary for the smart wager module 115 to initiate an appropriate Smart Contract. The smart contract creator 210 then creates a Secret for the Smart Contracts and notifies the lightning service provider manager module 120.

The smart wager module 115 can also include a connect software development kit (SDK) module 220 (shown in FIG. 2) that is configured to connect the smart wager module 115 with the user's cryptocurrency wallet thereby facilitating and simplifying sending, receiving and displaying user's wallet balances. FIG. 2 illustrates the functionality of the SDK module 220. In particular, the user first selects its wallet from a list of supported cryptocurrency wallets and logs in to its wallet. The user then gives to (i) display the wallet balance; receive payments in specified cryptocurrency, and send payments with optional limits. Additionally, the SDK module 220 can enable the user to make “in-app” purchases within the system 100.

As shown in FIG. 2, the smart wager module 115 also configured to request payment from the users in the Wager, and when the smart wager model 115 informs the arbiter module 110 that the payment is received, the arbiter module can take appropriate action. The action can depend on the use case the system 100 is being implemented for. For example, in the case of a skill-based wagering game, the Arbiter would notify ‘the game’ that the player can start their turn because the payment was received. In the case of peer-to-peer sports betting, the arbiter would be signaling to the operators website that the open wager is matched, and the status should be updated in the user interface. The smart wager module 115 is also configured to receive a notification from the Arbiter before settling the Smart Contracts in the smart wager module 115.

More specifically, as shown in FIG. 2, the arbiter module 110 provides inputs 240 to the smart contract creator 210, such as Wager Terms, User Identities and Smart Contract type. The arbiter module 110 receives the Smart Contract Wager and requests payment from the users 260. The smart wager module notifies the arbiter module 110 if payment was processed 270. After the event, the arbiter module 110 alerts the smart wager module 115 of the winning user 280. Once the wager is settled, the arbiter module 110 is notified that the wager is settled.

The smart wager module 115 includes the Smart Wager API 410 to create, manage, and retrieve status updates of Smart Wagers. The Smart Wager API 410 can include a protocol of web hooks and web requests to create and receive notifications about the Smart Wagers.

The smart wager module 115 can have Create Module (not shown) to create a Smart Wager. In particular, the Arbiter passes information about the wager, for example, a user information and Wager terms, and the like, and a wager id is returned to use for tracking the wager and adding users to the wager.

Add-user feature (not shown) of the smart wager module 115 adds a user to a Smart Wager. In particular, the Arbiter passes user information and provides payment instructions, that the Arbiter will pass back to the user to pay to enter into the wager. This process will create an appropriate Smart Contract as described in more detail below. At least one user needs to be added, but multiple users can be added.

According to embodiment of the present invention, Smart Contract created in the smart wager module 115 can allow a ‘routing fee’ taken as payment for non-custodially routing the payment. The smart wager module 115 can also contain the identity of the Arbiter, so a revenue share of the routing fee can be split between the smart wager module 115 provider and the arbiter, if they are different entities. For example, in the case of a sports book, it is possible for a provider to run their own arbiter and oracle implementation, and just use the smart wager module 115 to settle the wager. In this instance, the entity running the smart wager module 115 is collecting fees, and can make an agreement with the company running the arbiter/oracle services for a revenue share.

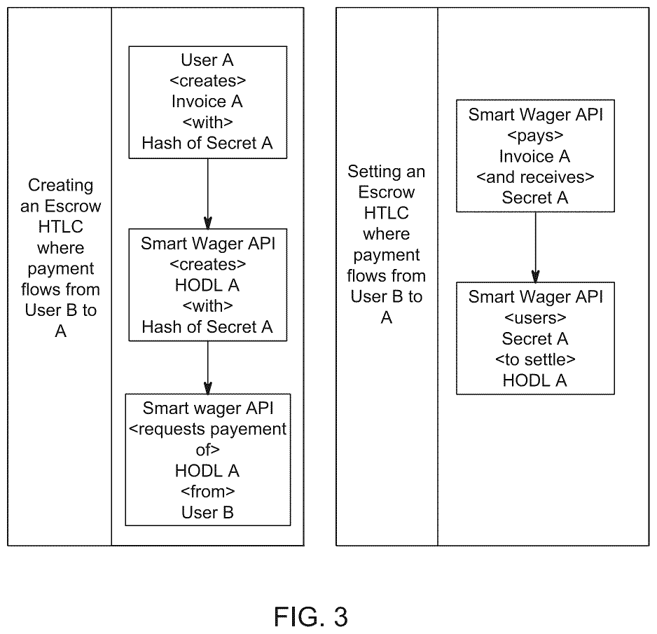

FIG. 3 further illustrates the smart contract creator 210, which according to embodiments of the present invention, creates Smart Contracts for the system 100. The arbiter module 110 can provide metadata about the user to the Smart Contract Creator, such as Wallet preference and the like, to recommend a Smart Contract Type to use when creating a new Smart Wager.

The types of Smart Contracts that can be created to facilitate the wager in the Smart Contract Creator 210 can include but are not limited to (as described below): A). Discreet Log Contract (DLC); B). Escrowed Hashed Time-Locked Contract; C). Escrowed Point Time-Locked Contract; D). Escrowed HODL Invoice, and E). Just-in-Time Escrow Contract.

### Discreet Log Contract (DLC)

To facilitate the creation of a DLC the Smart Contract Creator 210 can be configured to perform the following:
1. Arbiter calls the add-users Smart Wager API 410.
2. Smart Contract Creator 210 creates a 2-of-2 multi signature transaction-“Funding Transaction”.
3. Smart Contract Creator 210 creates Contact Execution Transactions (CET) for the Wager Terms and outcomes of the wager.
4. Smart Wager System 100 creates a signature for each of these transactions, so only the winning CET will be executed until the Secret is used for a signature for the transactions.
5. add-users Smart Wager API 410 returns the transactions for the users to sign.
6. Wait for this transaction to be mined using the blockchain ledger.
7. Arbiter passes the signed CETs from the users in via the add-cets Smart Wager API 410
8. When the Smart Wager sees that the Funding Transaction is paid and has the signed CETs-Notify the Arbiter via the invoice-paid webhook.

When the winner is determined by the Oracle the Arbiter passes this proof/result to the settled Smart Wager API 410, to execute the DLC Smart Contract and satisfy the result of the wager. The DLC executes upon the predetermined parameters of the contract. The signature that matches the outcome is used to sign the winning CET.

### Escrowed Hashed Time-Locked Contract

As illustrated in FIG. 3, in the Hashed Time-Locked Contract (HTLC) Escrow, the Smart Contract Creator 210 establishes a payment chain of HTLCs between the users where the LSP Manager is within the chain, i.e., a hop on the payment chain. That is, the LSP Manager facilitates a non-custodial escrow-like environment in the chain and can both control which payment chain settles and take a ‘routing fee’, while never touching user funds. The routing fee can be split with the Arbiter.

As shown in FIG. 3, User A supplies an invoice (Invoice A) to the Arbiter, where they want their winnings to be sent if they win. The Arbiter uses the Smart Wager API 410 to create a HODL invoice using the hash of the secret (HODL A). The same process is completed for the second user, User B creates Invoice B and HODL B. User A should pay HODL B, and User B should pay HODL A, which completes the setup of the wager contract. Settlement is then executed by the Smart Wager API 410, paying the winning users Invoice to reveal the secret, corresponding to the Invoice hash. This secret is then used to settle the HODL invoice. In other words, if User A won, Smart Wager pays Invoice A, to reveal the secret. Smart Wager then uses the secret to settle HODL A and the payment from User B to A is complete. Invoice B is never paid. And HODL B expires or is cancelled.

FIG. 4 illustrates an embodiment of the present invention where the smart wager module 115 receives a fee for routing of the wager between a User A and a User B. For purposes of this example, the User A wagers 100 sats and the User B also wagers 100 sats. The winner of the wager receives 180 sats, and the Smart Wager API 410 “rakes” 20 sats. This is achieved through the Smart Wager API 410 creating a difference in the HODL invoice. More specifically, Arbiter calls the add-users Smart Wager API 410, passing in Invoice A and Invoice B with the User data. These are the invoices that the Smart Wager API 410 should pay when one of the user's wins. Smart Contract Creator 210 then creates two HODL invoices and returns them in the response of add-users command. The Smart Wager API 410 awaits for the HODL invoices to be paid. When both HODL invoices are paid, Smart Wager notifies the Arbiter via the invoice-paid webhook. The Arbiter will notify the API of the UserId for the winner via the winner API. Smart Wager API 410 will pay the winning user's invoice, cancel the HODL invoice the winning user paid, then claim funds from the User who lost, settling the HODL invoice by revealing the secret disclosed when paying the winning user's invoice.

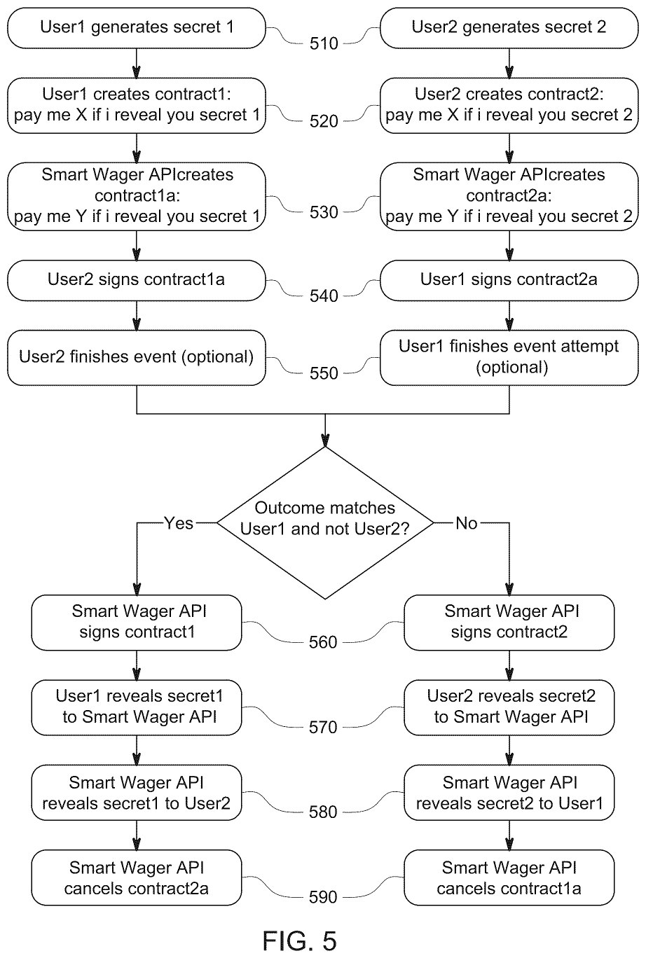

FIG. 5 shows a flow chart of creating a wager between two players and conditionally paying and settling one chain. As shown in FIG. 5, both users generate a secret 1 and secret 2 510 and subsequently a lightning invoice (e.g., bolt 11) to receive potential winnings from the other user, shown as a contract 1 and contract 2 520. The Smart Wager Module 410 creates new lightning invoices using the same secrets, a contract 1a and contract 2a 530. These are HODL invoices. User1 pays contract 2a, and user 2 pays contract 1a. This is the ‘signing’ step 540. Once both users have paid/signed the contracts generated by the Smart Wager, the event can take place 550. Once the event is completed and the winner is known, the Oracle module will notify the Smart Wager API 410 of the winner.

If user 1 wins, the Smart Wager API 410 will pay contract 1 from user 1 (i.e., sign) 560, and atomically receive the secret from user 1 570. With this secret, the Smart Wager can send it to user 2 and claim the funds user 2 sent to contract 1a prior to the event 580. Finally contract 2a id cancelled, and the funds are unlocked and made available again to user 1 590.

### Escrowed Point Time-Locked Contract

In case of Escrowed Point Time-Locked Contract (PTLC), the Smart Wager API 410 will construct and settle escrowed PTLCs in the same way as escrowed HTLCs. Instead of using the hash secrets for the escrow, PLTC signature adaptors will be used to create an escrowed contract.

### Escrowed HODL Invoice

With respect to Escrowed HODL Invoice contracts, the Smart Wager API 410 creates HODL Smart Contracts between users via the following steps:
1. The add-users Smart Wager API 410 creates a unique Secret for each user. The API response returns a hash of each secret.
2. The Arbiter sends each user their hash to create a HODL Invoice.
3. If the Arbiter has wallet permissions, it will create the HODL invoice on behalf of the users.
4. The Arbiter receives the HODL invoice from each user.
5. Arbiter exchanges the invoices between the users.
6. Users pay the HODL invoices
   a. Arbiter verifies payment was sent with read only access to user wallets.
   b. Arbiter manually notifies the Smart Wager API 410 that the invoices are paid via invoice-paid.
7. Once payment has been made (but not settled) the wager is considered entered into or ‘in contract’.

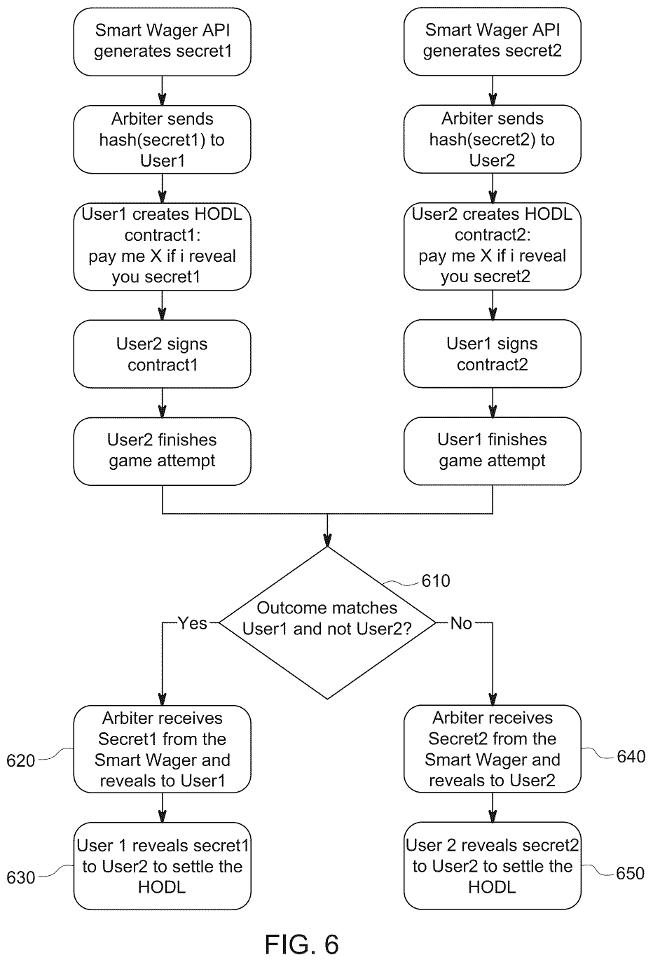

FIG. 6 illustrates a settlement of a Wager by the system 100 using Escrowed HODL Invoice contracts. When the event concludes, the Arbiter confirms the results with the Oracle. The Arbiter then uses the winning user's Smart Wager API 410 and reveals the Secret for only the winning user of the event 610. In other words, only the winning user can settle their HODL invoice and receive the funds, thereby obtaining the lost user's Stake. This Secret is sent to the winning user 620, so that the winning user can settle their HODL invoice 630. The contract that the winning user paid to the losing user will automatically cancel or time out 640 because the Smart Wager API 410 will not reveal the losing user's secret. The winning user's HODL invoice will be refunded based on the contract expiration 650.

### Just-In-Time Escrow Contract

If Just-in-Time Escrow Contract is selected the user funds remain in custody of Smart Contract Creator 210 only for the period of the Wager. In this case, the Smart Wager API 410 creates the Just-in-Time Escrow Contract using the following steps:
1. Arbiter calls the add-users Smart Wager API 410, passing in the user's data.
2. SCC creates two invoices and returns them in the response of add-users
3. Smart Wager API 410 waits for the invoices to be paid.
4. When the invoice is paid, smart wager module 115 notifies the Arbiter via the invoice-paid webhook.
5. The Arbiter will notify the API of the UserId for the winning user via the winning user's API.
6. Smart Wager API 410 will send the reward to the winning user.

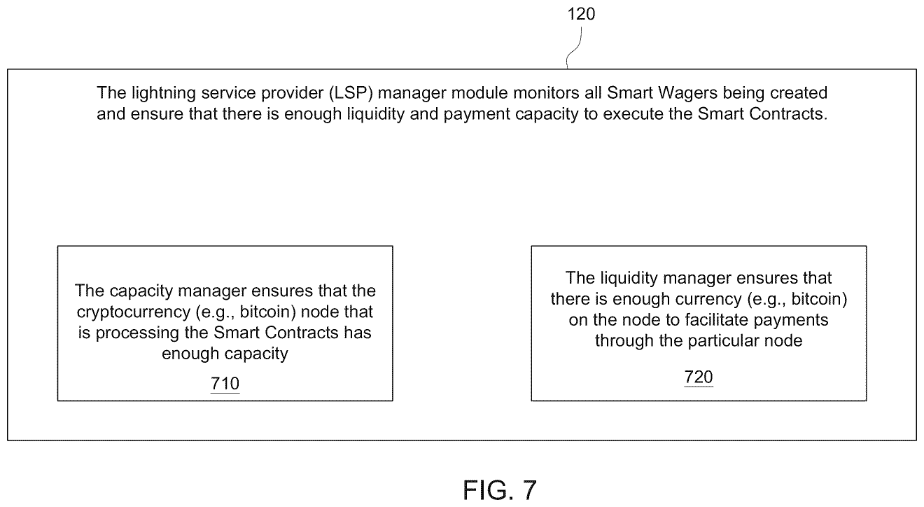

As shown in FIGS. 1 and 7, the system 100 is provided with the lightning Service Provider (LSP) manager module 120. The purpose of the LSP manager module 120 is to ensure the Smart Contracts can settle on the Lightning Network. In particular, the LSP manager module 120 is configured to monitor all Smart Wagers being created and ensure that there is enough liquidity and payment capacity to execute the Smart Contracts. The LSP manager module 120 has two core modules: a capacity manager 710 and a liquidity manager 720. The LSP manager module 120 maintains multiple subnetworks (not shown). Each subnetwork nodes organized in a star topology with nodes connect to a central node via private channels. Applications can operate on selected channels within their subnetworks, ensuring compliance with their specific regulatory requirements.

The capacity manager 710 ensures that the cryptocurrency (e.g., bitcoin) node that is processing the Smart Contracts has enough capacity. For example, there is a limited number of HTLCs that can be active within a payment channel at one time. The capacity manager 710 ensures that there is sufficient channel availability to meet the demand, which is the number of users trying to make bets concurrently. Since payment channels have a hard limit of active concurrent payments, the demand is managed by increasing and decreasing the number of channels. The capacity manager 710 first creates new channels if it is predicted that there will not be enough channels to meet the demand. The capacity manager 710 can notify the Smart Wager API 410 if capacity limits have been met. The capacity manager can also close channels to reduce the capacity if not required.

The main purpose of the liquidity manager 720 is to ensure there is enough currency (e.g., bitcoin) on the node to facilitate payments through the particular node. The liquidity manager 720 can rebalance liquidity among channels. That is, the liquidity manager 720 can loop-in bitcoin from on-chain to a lightning channel that requires a top up, or alternatively, loop-out bitcoin from a channel to on-chain if the channel balance is not needed.

The system 100 is also configured that Smart Wagers can be extended from cryptocurrency wagering to Fiat (i.e., government-based currency) wagering. Two users can participate in a wager and perceive Fiat amounts for their wager. The users entering the wager do not need to be using the same currency.

The lightning service provider (LSP) manager module 120 can use cryptocurrency rails 730 to set up and settle the Smart Wager. For example, in a two-user wager, User A using Dollars ($) and User B using Sterling (£), the lightning service provider (LSP) manager module 120 can use a fiat exchanger 230 (shown in FIG. 1) to exchange Fiat into Bitcoin or another cryptocurrency in real-time as the contract is entered into. When the user is presented Wager Terms by the Arbiter in Fiat currency, the user receives a bitcoin denominated Smart Wager for the equivalent amount of Fiat advertised. The user does not need to interact with bitcoin denomination. The user pays the Smart Wager from his or her Fiat wallet. The Fiat wallet will show the user the Smart Wager in Fiat denomination. Upon accepting the Wager Terms in the Fiat wallet, the wallet converts Fiat to cryptocurrency (e.g., Bitcoin) instantly and pays the Bitcoin invoices in the smart wager module 115. The conversion occurs without user's participation. In other words, the user experience presents the perception of wagering in Fiat. Price volatility between bitcoin and Fiat for the duration of the wager can be absorbed by setting an appropriate rake fee for the wager services.

The oracle module 125 (shown in FIG. 1) is configured to confirm the winner. In this instance, the Arbiter acts as the Oracle in providing the outcome of the event. The Arbiter can report results from an external event, or in an event in which users themselves are participating, the Arbiter may use an event verifier 127 to confirm that the event was not tempered with and users followed the event rules.

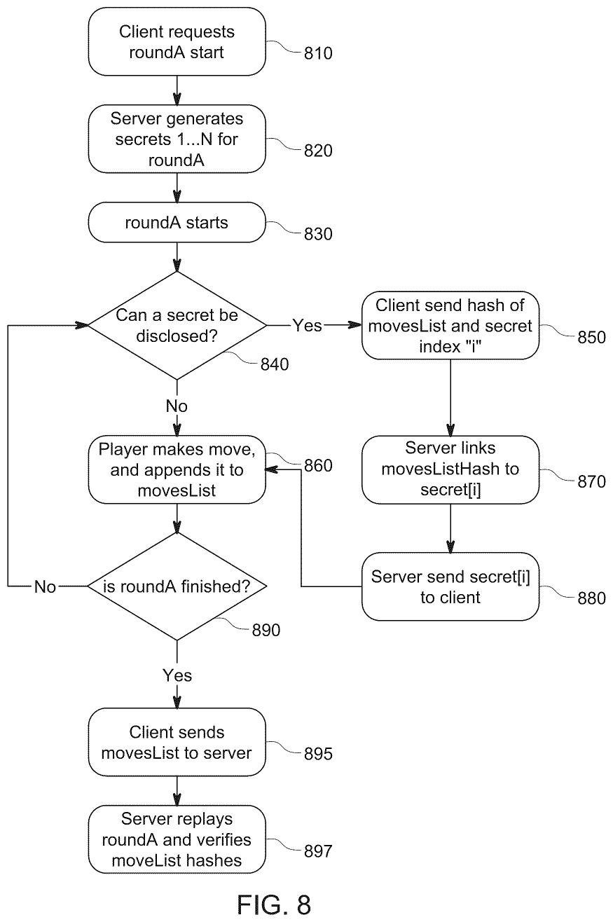

Online events with uncertain future outcomes that involve competitive play or real money wagering necessitate heightened security measures to maintain the fairness of the competition. Online events involving user participation and are skill-based, offer competition, wagering, or loyalty rewards are frequent targets of bad actors attempting to cheat or favorably alter the outcome of said events. As illustrated in FIG. 8, the event verifier 127 verifies each time an event that occurs in an online environment, confirming the legitimacy of the event occurrence. The event verifier 127 provides an additional level of security that enables users to trust the validity of the outcome results of an online event.

Essentially, the event verifier 127 safeguards online events against cheating by comparing event actions to anticipated outcomes generated by a server (not shown). When the submitted action deviates from an expected outcome, cheating is detected. This is because the user is attempting to manipulate their input to exploit the event server in some unauthorized way.

As shown in FIG. 8, when a client requests to start a new round 810, the server generates a sequence of secrets 820 associated with the new round. Each secret represents a random number (like a fair dice roll, card draw, and so on). All secrets are generated before the round starts, so the server cannot affect the round result.

When the round starts 820, during the round, the user makes moves until the event algorithm (that runs locally on the client's device) detects that a new secret must be disclosed 840 to the client (for example, a card revealed in a card game). In this instance, the client hashes his previous moves from the round start 850 and sends them as a “checkpoint” to the server along with the secret index. The server permanently links the received checkpoint to the secret 870 and sends it to the client 880 so the “event algorithm” can continue running. The procedure is repeated until the event algorithm detects that the round is finished 890. The client sends the list of his actions to the server 895 to get the round accepted.

The server replays the round using received moves, stored secrets, and checkpoints. The same event algorithm as the client is being used, but instead of linking checkpoints to secrets, the server checks that the linked checkpoint is the same as the evaluated result. The server accepts the round only if all linked checkpoints match with evaluated checkpoints 897.

This process results in minimal server costs (calls and storage) as well as an improved user experience, because the client is communicating with the server only when necessary. Checkpoint verification is delayed until the event ends, which allows storing checkpoints without knowing the rules of the event algorithm. The cost of using the same event algorithm on the client and server-side development is greatly reduced. Users can also check this verifier to transparently view the moves of their opponent(s) after the event is completed.

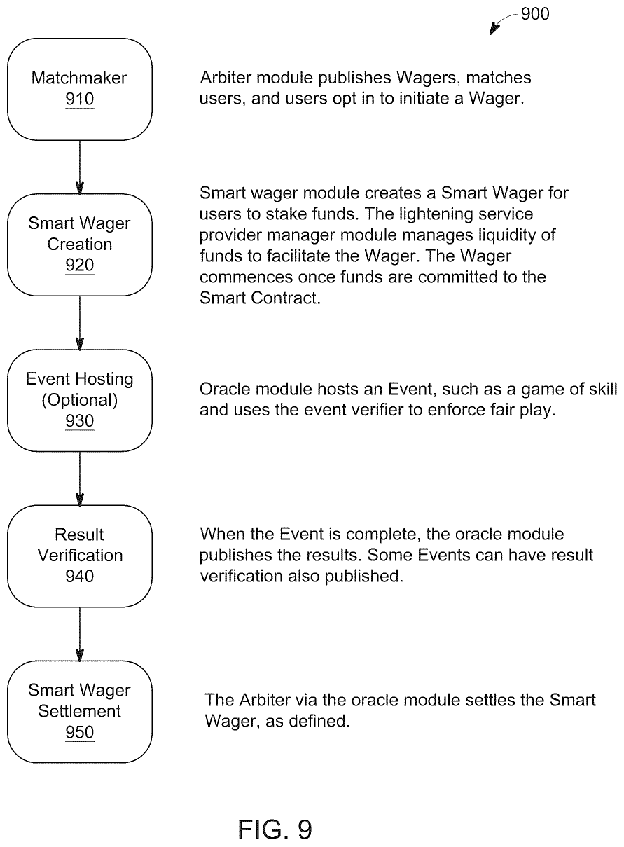

FIG. 9 illustrates a method 900 according to the present invention that is configured to facilitate a non-custodial, peer-to-peer wagered events among users of an Event using the arbiter module 110, the smart wager module 115 to create and manage Smart Contracts that incorporate the Wagering Terms, the lightning service provider manager module 120 to ensure a payment capacity and a liquidity thereby allowing a settlement of the Smart Contracts, and the oracle module 125 to verify and confirm a validity of the Wagered Event.

The method is best understood by devising it into a five step process to create a generic wagering application. The steps of method 900 can include a matchmaking step 910, a smart wager creation step 920, event hosting steps 930, which can be optional, a result verification step 940, and a wager settlement step 950.

As shown in FIG. 9, in the matchmaking step 910 the arbiter module 110 publishes Wagers, matches users, and users can opt-in to initiate a Wager.

In smart wager creation step 920, the smart wager module 115 creates a Smart Wager for users to stake funds. The lightning service provider manager module 120 manages liquidity of funds to facilitate the Wager. The Wager commences once funds are committed to the Smart Contract.

In the event hosting steps 930, oracle module 125 can host an Event, such as a game of skill and uses the event verifier to enforce fair play.

In the result verification step 940, upon the completion of the event, the oracle module 125 publishes the results. Some Events can have result verification also published.

In the wager settlement step 950, the Arbiter via the oracle module settles the Smart Wager.

While the system 100 of the present invention can be applied in any situation where two or more parties wager on the outcome of an uncertain event, this disclosure is especially relevant to three major use cases, namely Online Game Wagering, Sports Betting, and Community Wagering as descried below.

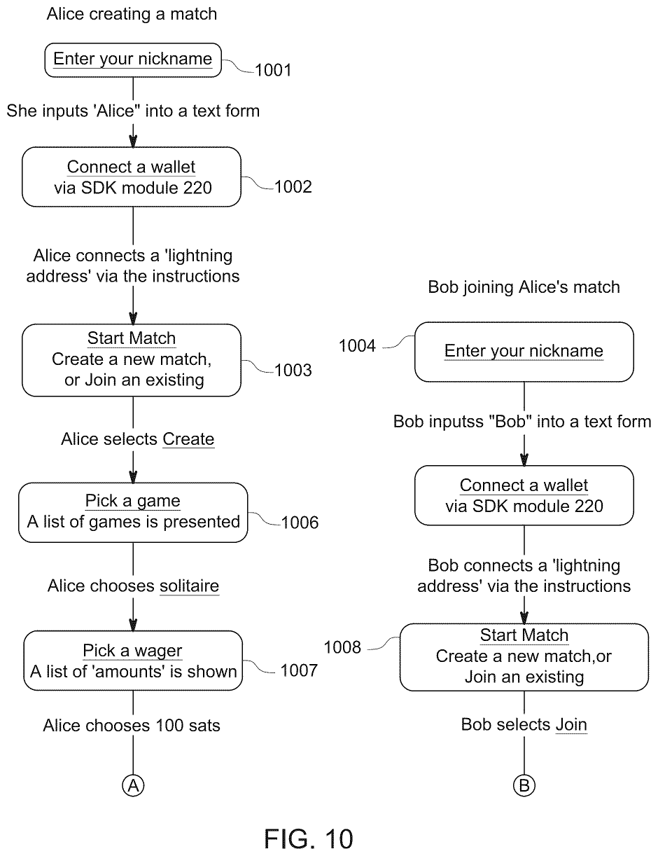

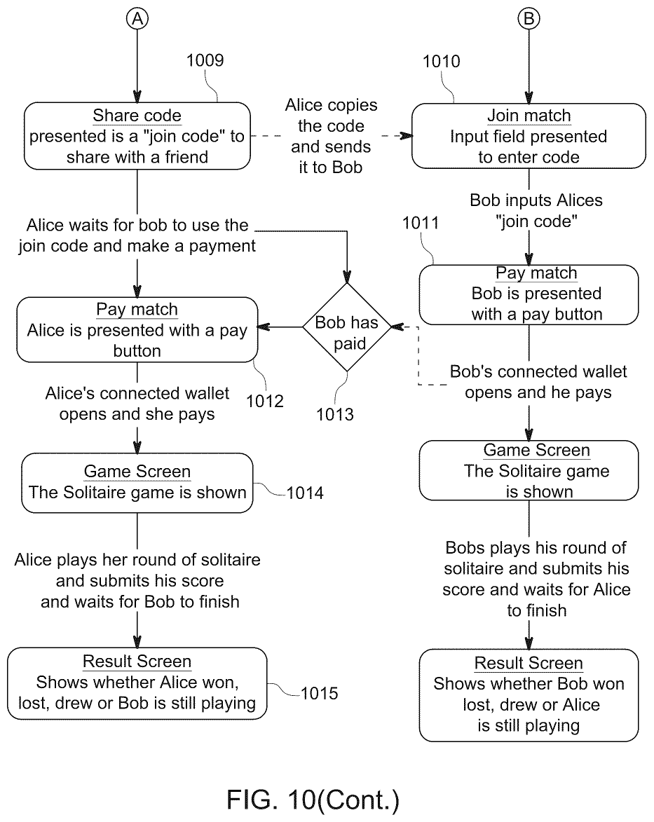

FIG. 10 illustrates a user interface flowchart of the system from the user's perspective. Where two users can create a match and the Smart Wager API 410 will construct the relevant invoices at the appropriate times to facilitate the wager using the Escrowed Hashed Time-Locked Contract (HTLC). A user 1 (Alice) enters her nickname 1001 and connects to her wallet via the SDK module 220 1002. Alice then stars a match 1003. A user 2 (Bob) enters his nickname 1004 and connects to her wallet via the SDK module 220 1005. Alice selects (picks) a game from the list of games she is presented 1006. Alice then picks a Wager from the list of wager amounts shown. Bob has a choice (same as Alice) to create a new match or join the existing match. In this scenario, Bob selects to join Alice's match 1008. Alice shares a code with Bob for him to join the match 1009, and Bob enters the code shared by Alice 1010. Bob then is presented with “pay” option 1011 and in this example Bob makes a payment 1012. The match is then played, in this example, a game of solitaire is played 1013 on the game screen. Next, after each user plays their respective round, the results are shared and winner is shown. The winning player receives payment as described in detail in for example, FIG. 5.

### Online Game Wagering

Online game wagering, frequently referred to as paid competitive gaming (PCG), consists of two or more users wagering on the outcome of a game, in which they themselves are participating directly in game play. This use case leverages all five steps of the method 900 according to embodiment of the present invention.

In this scenario, an entity, such as a mobile gaming company, uses the entire system 100 of the present invention to match make users, construct wager contracts, facilitate events with round verification, and provide event outcomes. The user, or player, submits a wager with associated Wager Terms, which is based upon the Event in which they are participating. The gaming company then uses the arbiter module 110 to either facilitate matchmaking (step 910) with another user in the ecosystem, or they match the terms of the wager on behalf of the company.

As the event takes place (i.e. the match occurs), the game company, using the oracle module 125, will provide event verification services using a round recorder 126 and event verifier 127 of the present invention. In using these tools, the game company can verify all actions taken in the event, and provide an official, or verifiable event outcome on which the wager will be executed. This event outcome will then be used by the game company, to facilitate the execution of the Smart contract using the arbiter module 115 of the present invention.

### Sports Betting

Sports betting also referred to as sports contests, sports gambling, or sports books, is the act of predicting event outcomes in a sports event and placing a wager on the results of the outcome.

An entity, such as a company offering sports wagering, betting, or other similar sports book-like activities will utilize the smart wager module 210 and the lightning service provider manager module 120 of the present invention. Match making (Arbiter) and event outcome reporting (Oracle) services likely occur outside of the disclosed system 100, as the company traditionally hosts their own bespoke services.

In this scenario, after the company internally matches wagers, they will utilize the smart wager module 115 of the present invention to construct a Smart Contract between the users. Once the event concludes and outcomes are collected, the company will act as the oracle (or work with an external oracle services), providing results to the smart wager module 115. The Smart Contract will then be executed and user funds will be non-custodially distributed based on the Wager Terms.

### Community Wagering

Community Wagering is fan-based, passionate communities frequently form around games, creating an additional competitive and social layer to any game ecosystem. Frequently, these communities host regular competitive events, playing against each other for titles or stake. The present invention can be used as a safer and more efficient tool for enabling participants in these communities to facilitate and execute peer-to-peer, non-custodial wagers.

Using the Nostr protocol network, a company hosting the system 100 can host a Nostr relay node for matchmaking where community users can post open wagers. Other users from the community can then match the other side of the wager via this relay.

The foregoing detailed description of the embodiments is used to further clearly describe the features and spirit of the present invention. The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for facilitating a non-custodial, peer-to-peer wagered event for users, the system comprising:
an arbiter module configured to facilitate a selection of wagering terms;
a smart wager module configured to create and manage smart contracts that comprise the wagering terms;
a lightning service provider manager module configured to ensure a payment capacity and a liquidity, thereby allowing a settlement of the smart contracts; and
an oracle module to verify and confirm a validity of the wagered event.

2. The system according to claim 1, wherein the arbiter module comprises:
a wager advertiser configured to publish available wagers to users via an interface, application programming interface (API), and/or social media applications thereby facilitating the users' engagement in the wagered event under the wagering terms;
a user matchmaker module configured to link users according to the users' selected the wagering terms; and
a wager resolution module configured to interact with the smart wager module when determining a winner settling the wagered event.

3. The system according to claim 1, wherein the smart wager module comprises a smart contract creator configured to initiate a smart contract prior to the wagered event and to create a secret, the secret being a private key or a value.

4. The system according to claim 3, wherein the smart wager module further comprises a smart wager application programming interface (API) having a protocol web hooks and web requests to send and receive notifications about the wagered event.

5. The system according to claim 3, wherein the smart contract comprises Discreet Log Contract (DLC), Escrowed Hashed Time-Locked Contract, Escrowed Point Time-Locked Contract; Escrowed (Hold on for Dear Life) HODL Invoice, and Just-in-Time Escrow Contract.

6. The system according to claim 1, wherein the lightning service provider manager module comprises:
a capacity manager configured to maintain a cryptocurrency node and ensure a sufficient number of channels are available to meet a demand; and
a liquidity manager configured to provide a sufficient amount of currency being available on the cryptocurrency node to facilitate payments through the cryptocurrency node.

7. The system according to claim 1, wherein the oracle module comprises an event verifier that determines a validity of the wagered event in an online environment by comparing event actions to anticipated outcomes generated by the wagered event.

8. The system according to claim 1, wherein the wagered event is an online game wagering, a sports betting event or a community wagered event.

9. A method for a non-custodial, peer-to-peer wagered event for users, the method comprising:
publishing an online non-custodial, peer-to-peer wagered event using a arbiter module and matching the users with the wagered event, wherein the users opt-in to initiate a wager;
creating a smart wager by a smart wager module, wherein the smart wager module comprises individual smart contracts for each user with associated the wagering terms;
optionally, hosting the wagered event in an online environment;
determining a validity of the wagered event in an online environment by comparing event actions to anticipated outcomes generated by the wagered event via oracle module, wherein the oracle module comprises an event verifier;
settling the smart wager through the arbiter module.

10. The method according to claim 9, wherein the arbiter module comprises:
a wager advertiser configured to publish available wagers to users via an interface, application programming interface (API), and/or social media applications thereby facilitating the users' engagement in the wagered event under the wagering terms;
a user matchmaker module configured to link users according to the users' selected the wagering terms; and
a wager resolution module configured to interact with the smart wager module when determining a winner settling the wagered event.

11. The method according to claim 9, wherein the step of creating a smart wager further comprises:
creating the smart contract prior to the wagered event; and
create a secret, the secret being a private key or a value.

12. The method according to claim 9, wherein the smart wager module further comprises a smart wager application programming interface (API) having a protocol web hooks and web requests to send and receive notifications about the wagered event.

13. The method according to claim 9, wherein the smart contract comprises Discreet Log Contract (DLC), Escrowed Hashed Time-Locked Contract, Escrowed Point Time-Locked Contract; Escrowed (Hold on for Dear Life) HODL Invoice, and Just-in-Time Escrow Contract.

14. The method according to claim 9, wherein the wagered event is an online game wagering, a sports betting event or a community wagered event.
